(19) United States
(12) Patent Application Publication
(10) Pub. No.: US 2015/0048180 A1
(43) Pub. Date: Feb. 19, 2015

(54) Flashlight and defensive spray apparatus

(71) Applicant: Michael H. Teig, Heber City, UT (US)

(72) Inventor: Michael H. Teig, Heber City, UT (US)

(21) Appl. No.: 14/121,220

(22) Filed: Aug. 11, 2014

Related U.S. Application Data
(60) Provisional application No. 61/866,414, filed on Aug. 15, 2013.

(51) Int. Cl. F41H 9/10; F21V 33/00

(52) U.S. Cl. CPC F41H 9/10; F21V 33/0076
USPC 239/289

(57) ABSTRACT

A flashlight and defensive spray apparatus, such as a flashlight and pepper spray combination apparatus, includes activation buttons for both the flashlight and the defensive spray component in close proximity to one another so as to facilitate activation of both components by a single thumb or finger of the operator, which may be desirable in emergency situations.

This application claims priority on U.S. provisional patent application No. 61/866,414, filed on Aug. 15, 2013, entitled FLASHLIGHT AND DEFENSIVE SPRAY APPARATUS, in the name of inventor Michael H. Teig, which application is hereby incorporated herein in its entirety.

### TECHNICAL FIELD

The present invention relates to a flashlight and defensive spray apparatus, such as a flashlight and pepper spray combination apparatus. The apparatus includes activation buttons for both the flashlight and the defensive spray component in close proximity to one another so as to facilitate activation of both components by a single thumb or finger of the operator, which may be desirable in emergency situations.

### BACKGROUND OF THE INVENTION

The present invention is particularly intended for use in situations where use of a flashlight and a defensive spray device may both be desirable, such as by police and/or military personal, and such as by civilians in self defense situations. In previous situations, a flashlight and a pepper spray device may each be carried separately by police and/or military personnel, or by civilians in self defense situations. In some prior art devices, a flashlight and a defensive spray component may be integrated into a single device. However, these devices generally include activation buttons positioned on opposite ends of the device, which makes simultaneous activation of the two components impractible or at least difficult. Such prior art devices, therefore, may not provide the effective and efficient defensive action required in emergency situations. There is a need therefore for a device that may allow activation of the two components simultaneously, and preferably, which allows for activation of both components by a single thumb or finger of the operator.

### SUMMARY OF THE INVENTION

The present invention provides a flashlight and defensive spray apparatus, such as a flashlight and pepper spray combination apparatus. The apparatus includes activation buttons for both the flashlight and the defensive spray component in close proximity to one another so as to facilitate activation of both components by a single thumb or finger of the operator, which may be desirable in emergency situations. In particular, the activation buttons may be positioned next to each other in an arrangement such that a single thumb of an operator may activate or deactivate both buttons individually without moving their thumb on the device. More particularly, the operator may rock or pivot the end of their thumb on the two buttons to activate or deactivate either of the two buttons as desired, without loosening or adjusting their grip on the device. This time efficient and effective arrangement of the activation buttons of the present device may mean the difference between life and death for the operator in hostile situations.

### BRIEF DESCRIPTION OF THE DRAWINGS

FIG. 1 is a front isometric view of one example embodiment of a flashlight spray apparatus.

FIG. 2 is a front view of the apparatus of FIG. 1.

FIG. 3 is a back view of the apparatus of FIG. 1.

FIG. 4 is a side view of the apparatus of FIG. 1.

FIG. 5 is an exploded side view of the apparatus of FIG. 1.

FIG. 6 is a detailed cross-sectional side view of the apparatus of FIG. 1.

FIG. 7 is a front isometric view of a second example embodiment of a flashlight spray apparatus.

FIG. 8 is a back view of the apparatus of FIG. 7.

FIG. 9 is a detailed cross-sectional side view of another example embodiment of a flashlight spray apparatus.

FIG. 10 is a detailed cross-sectional side view of yet another example embodiment of a flashlight spray apparatus.

### DETAILED DESCRIPTION OF THE PREFERRED EMBODIMENTS

The invention discloses a combination flashlight and defensive spray device that includes two activation buttons arranged to allow individual activation or deactivation by movement of a single thumb of an operator, without requiring shifting of the operators hand during use.

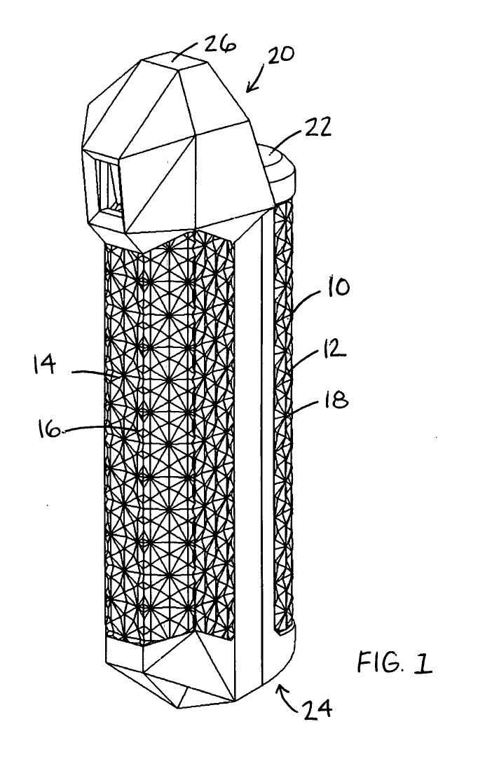

FIG. 1 is a front isometric view of a first example embodiment of a flashlight spray apparatus 10. The flashlight/pepper spray combination apparatus 10 incorporates a self-defense flashlight 12 with concealed chemical self-defense spray 14. The spray canister 16 is positioned parallel to the battery compartment 18 of the flashlight with the actuator 20 of the spray being positioned parallel to and slightly above the light switch 22. The light switch 22 is an “end switch” and is positioned on the butt end off the flashlight, opposite the end where the LED 24 is located. Both the spray switch 20 and the light switch 22 are operated with a single thumb of the operator.

The spray actuator 20 is located behind and slightly above the button 22 on the light and is accessed by inserting the thumb over the top of the light switch and resting it on the spray button 20 or “actuator.” The relationship of the spray actuator 20 and the lights multi-mode switch button 22, as well as the actuation pressure of each, has been designed to allow the operator to either move his thumb easily from one button to the other or the operator (user) can position his thumb on the spray actuator to enable an immediate self-defense response without having to move his thumb. Thus the thumb can be kept in the spray position while still being able to operate the multi-mode light button 22 by simply arching his thumb but not moving it from its position above the spray actuator 20. This simple action causes or allows the upper knuckle of the thumb to press down on the light button without applying pressure on the spray button.

A hood 26 over the spray button 20 is designed to prevent accidental or unintentional actuation of the spray by foreign objects. Additionally, a safety tab can be inserted under the actuator between the actuator button 20 and the top of the canister to prevent actuation while not in use.

The light function provides a unique sequencing feature with a “panic” mode that, regardless of the last mode the light was in, when initially turned on, it assumes a threat and goes into a high intensity blinding strobe designed to surprise and disorient the attacker. The user can bypass the panic mode and go to constant high beam by pushing the switch 22 down twice within approximately one-second. This can be done whether in momentary or click mode. In momentary mode, the user only has to push the button 22 partially down without clicking it. If left in that position for more that a second, it will go off when released. If left in that position for less than a second and pushed down again, partially or all the way, it will go to the next mode. There are four modes that include panic strobe, High, Low and SOS.

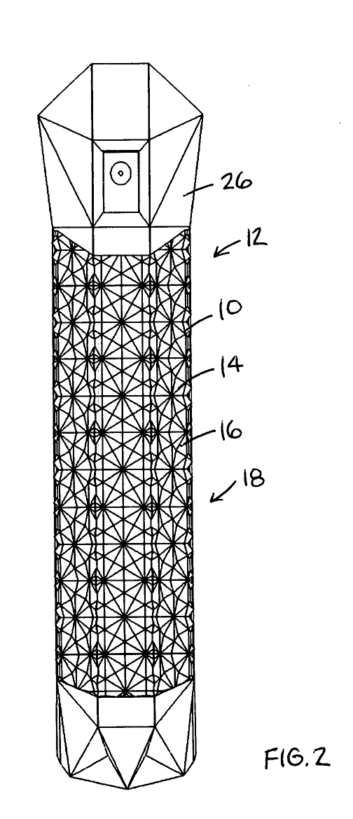

FIG. 2 is a front view of apparatus 10 of FIG. 1.

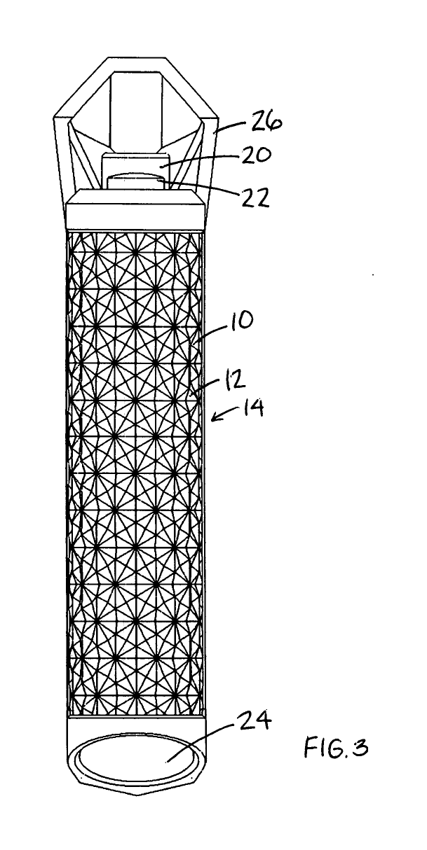

FIG. 3 is a back view of apparatus 10 of FIG. 1.

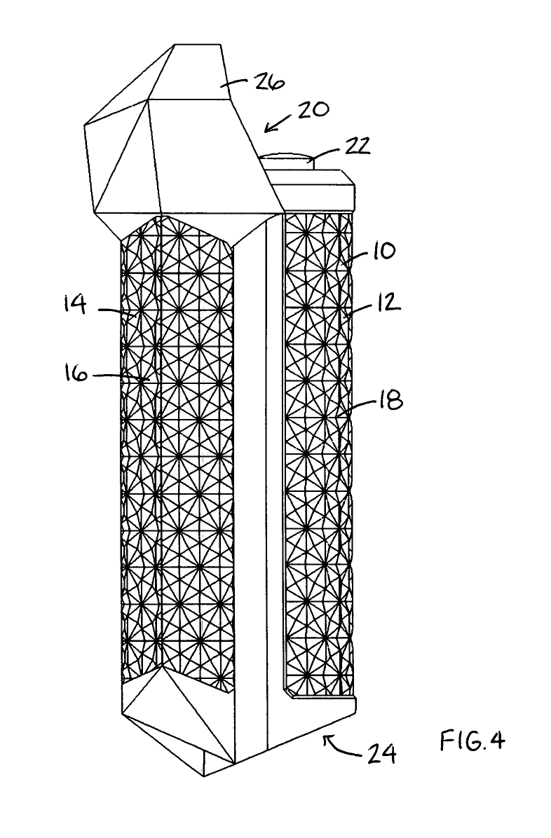

FIG. 4 is a side view of apparatus 10 of FIG. 1.

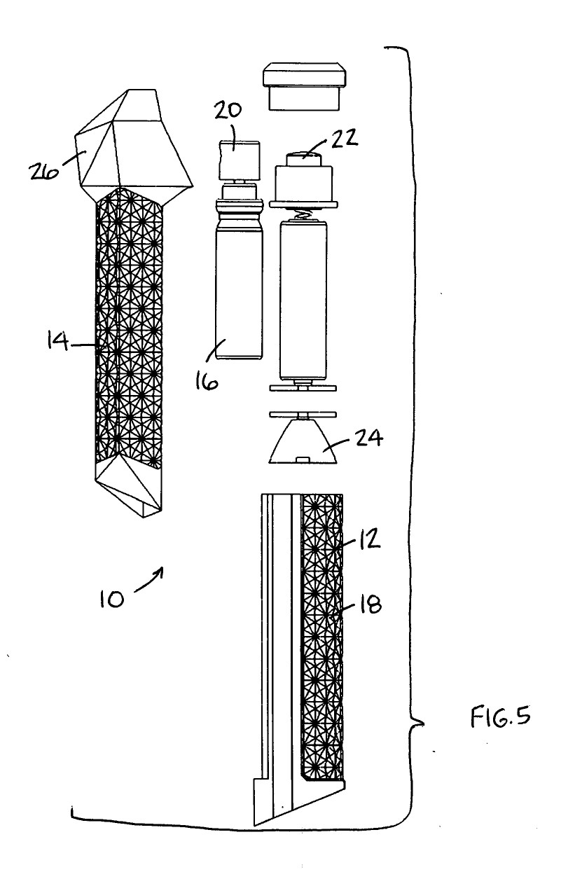

FIG. 5 is an exploded side view of apparatus 10 of FIG. 1.

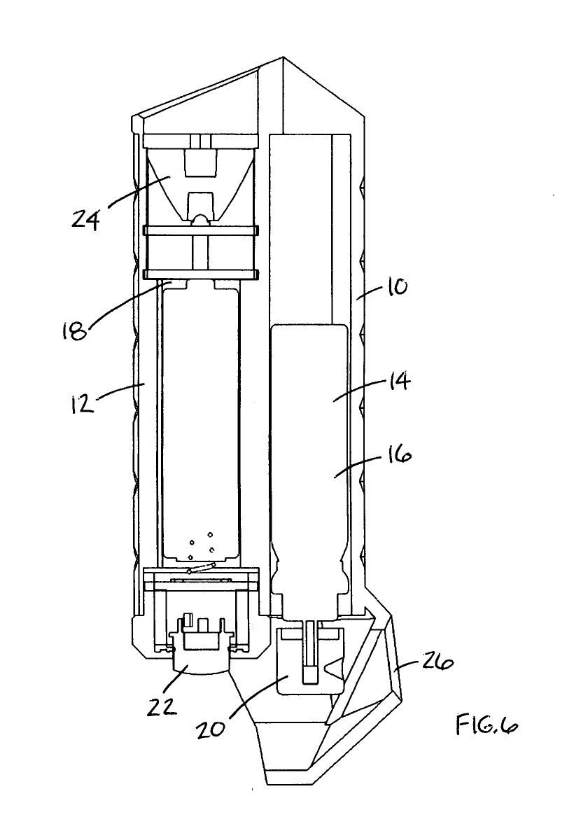

FIG. 6 is a detailed cross-sectional side view of apparatus 10 of FIG. 1.

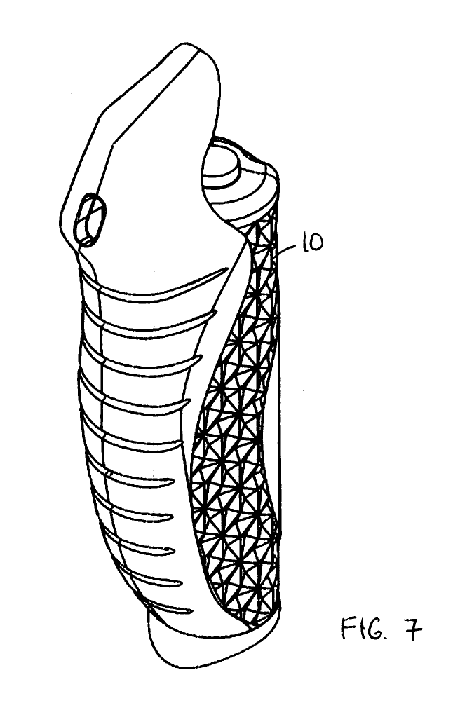

FIG. 7 is a front isometric view of a second example embodiment of a flashlight spray apparatus 10. In this embodiment the shape of the outer casing of apparatus 10 is slightly modified from the embodiment shown in FIG. 1. The functional parts of the apparatus remain the same as in FIG. 1, however, this embodiment includes a more rounded, less angular external design.

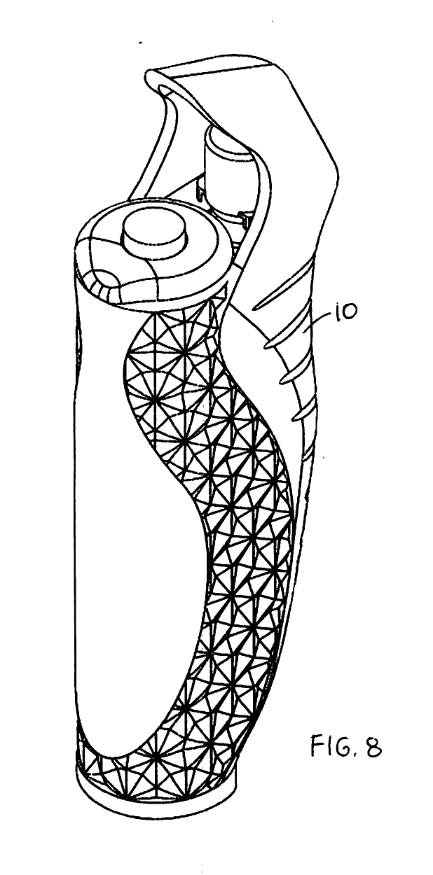

FIG. 8 is a back view of the apparatus of FIG. 7.

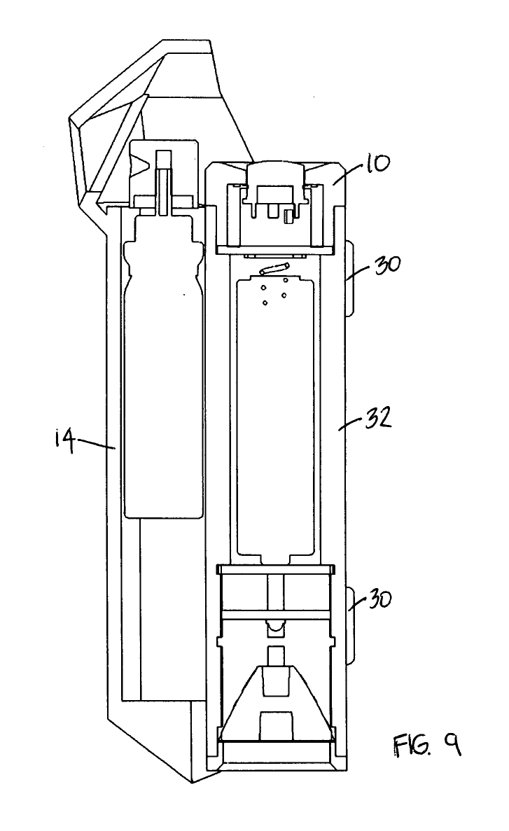

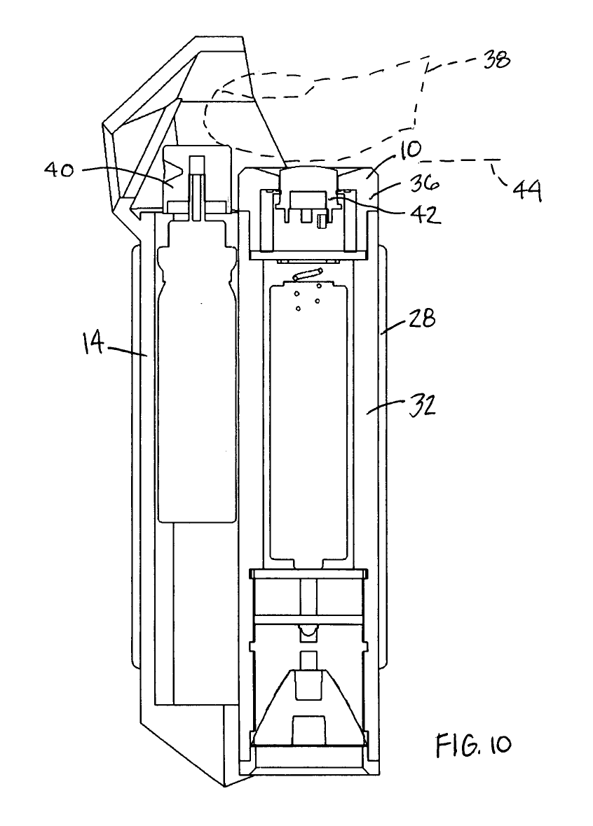

FIG. 9 is a detailed cross-sectional side view of another example embodiment of a flashlight spray apparatus 10. This third embodiment uses either a sleeve 28 (FIG. 10) or two strap-like fasteners 30 (FIG. 9) to secure the pepper spray portion 14 of the apparatus 10 to a variety of third party flashlights 32 that may vary slightly in size but are close to the size of the flashlight compartment 12 in the apparatus shown in FIGS. 1 and 2. This is done by using either a rubber sleeve 28, or bands 30, that slips over the pepper spray portion which houses the pepper spray and the pepper spray actuator, and secures it to the third party flashlight, holding them securely together in a position that the combination may be used essentially the same as the apparatus shown in FIGS. 1 and 2. The two fasteners 28 and/or 30 may be made of a variety of materials including plastic, rubber, leather, vinyl or any other material that may effectively secure the pepper spray compartment 16 to the third party flashlight 32.

FIG. 10 is a detailed cross-sectional side view of yet another example embodiment of a flashlight spray apparatus utilizing a sleeve 28.

Because the embodiments shown in FIGS. 9 and 10 utilize a typical tactical flashlight design with an end switch rather than a side switch and add the elements necessary to convert it to a self-defense device with concealed pepper spray or other chemical agents, it is adaptable to all similar lights and will be manufactured and sold also as a modification to other tactical lights to convert them to the type of apparatus shown in FIG. 1.

FIG. 10 shows first activation button 40 and second activation button 42 both positioned on the same end 36 of the body of apparatus 10 such that both buttons may simultaneously be depressed by an operator's thumb 38 to simultaneously activate the spray and light functions of apparatus 10. Buttons 40 and 42 may be referred to as positioned adjacent to one another, positioned on the same end of the body of apparatus 10, positioned substantially in the same plane 44, positioned next to each other, and/or positioned in a single operational or activation location, which individually all mean that an operator may activate two distinct functions of apparatus 10 without shifting their hand on the device 10. In other words, thumb 38 of an operator can activate both buttons simultaneously or individually without shifting the position of their thumb 38 on apparatus 10, which may be very important in stressful defensive situations.

In the above description numerous details have been set forth in order to provide a more through understanding of the present invention. It will be obvious, however, to one skilled in the art that the present invention may be practiced using other equivalent designs.

I claim:

1. A self defense apparatus, comprising:
a body containing a light source and a container that contains a defensive spray material;
a first activation structure that activates said defensive spray material to exit said container; and
a second activation structure that activates said light source to produce a light beam;
wherein said first activation structure and said second activation structure are positioned adjacent one another.

2. The apparatus of claim 1 wherein said body comprises an elongate structure that includes a first end and wherein said first and said second activation structure are both positioned on said first end of said body.

3. The apparatus of claim 1 wherein said first and said second activation structures are positioned such that an operator's thumb simultaneously depresses both structures to simultaneously activate both activation structures.

4. The apparatus of claim 1 wherein said first and said second activation structures are positioned such that an operator's thumb simultaneously contacts both structures.
